(19) United States
(12) Patent Application Publication
(10) Pub. No.: US 2002/0068115 A1
(43) Pub. Date: Jun. 6, 2002

(54) FILLED BATTER-DERIVED FOOD PRODUCTS

(76) Inventor: SUSAN M. HAYES-JACOBSON, MINNEAPOLIS, MN (US)

Correspondence Address: MARK W. BINDER, KAGAN BINDER, PLLC, 221 MAIN STREET, SUITE 200, STILLWATER, MN, 55082-5021, US

(21) Appl. No.: 09/443,559

(22) Filed: Nov. 19, 1999

(51) Int. Cl. A21D 10/04

(52) U.S. Cl. 426/94; 426/138; 426/282

(57) ABSTRACT

Batter-derived food products were made that have a continuous spongy structure with a filling encased within the spongy structure. In some embodiments, filled pancakes with encased filling were made. The filled food products were made by depositing the filling on partially cooked components. After the filling was deposited, the partially cooked components were heated further to generate a fully cooked food product with filling encased within the cooked food product. In some embodiments, a pancake component with the filling deposited was combined with another pancake component and further heated to seal the edges and produce a filled pancake with the filling sealed within the pancake.

### BACKGROUND OF THE INVENTION

The invention relates to filled food products and more particularly to filled batter-derived products such as pancakes. The invention further relates to a method of making these filled food products.

Businesses involved in commercial food production consider food characteristics such that the food is desirable to a significant number of customers. While consumers desire food with appealing taste and texture, they also demand food products that are simple and fast to prepare. In addition, food products that are not messy to eat or that do not require an extensive clean up regimen are also desirable.

A variety of batter based food products, such as pancakes, waffles and muffins have wide appeal. Pancakes with toppings such as fruit are desirable to consumers. Frozen pancakes that can be reheated, when desired, are available for consumer use. The consumer reheats the frozen pancakes and tops the pancakes with the desired topping. Another example of a pancake product includes a rolled up pancake in which a topping is spread on the surface of the cooked pancake prior to being rolled up. The rolled up pancake alleviates the consumer from having to supply a topping for the pancake. Upon reheating and/or during consumption, however, the topping in the rolled up pancake can leak out creating a mess for the consumer.

### SUMMARY OF THE INVENTION

In a first aspect, the invention pertains to a filled food product comprising a food structure and a filling, wherein the filling is encased within the food structure. The food structure comprises cooked, hydrated flour and a moisture content between about 20 percent by weight and about 60 percent by weight.

In a further aspect, the invention pertains to a method of making a filled food product comprising combining two food components with at least one food component having an ungelatinized top layer wherein the ungelatinized top layer interacts with the other food component after combining and wherein one of the food components comprises a filling. The method also includes bonding the two combined food components to encase the filling within the bonded structure.

In an another aspect, the invention pertains to a method of making a filled food product comprising depositing a filling within a partially gelatinized food composition. The method further comprises heating the food composition further to produce the filled food product.

### BRIEF DESCRIPTION OF THE DRAWINGS

FIG. 1A is a photograph showing a cross-sectional view of a pancake component removed from a cooking surface when the center of the top surface reached a temperature of about 120° F.

FIG. 1B is a photograph showing a cross-sectional view of a pancake component removed from a cooking surface when the center of the top surface reached a temperature of about 140° F.

FIG. 1C is a photograph showing a cross-sectional view of a pancake component removed from a cooking surface when the center of the top surface reached a temperature of about 160° F.

FIG. 1D is a photograph showing a cross-sectional view of a pancake component removed from a cooking surface when the center of the top surface reached a temperature of about 180° F.

FIG. 1E is a photograph showing a cross-sectional view of a pancake component removed from a cooking surface when the pancake component was completely cooked.

FIG. 2A is a microscopy image of a pancake component that was removed from a cooking surface when the center of the top surface reached a temperature of about 120° F.

FIG. 2B is a 11.5× magnification photograph of a cross-sectional view of a pancake component removed from a cooking surface when the center of top surface reached a temperature of about 120° F.

FIG. 2C is an unmagnified photograph of a cross-sectional view of a pancake component removed from a cooking surface when the center of the top surface reached a temperature of about 120° F.

FIG. 2D is a photograph of the top surface of a pancake component removed from a cooking surface when the center of the top surface reached a temperature of about 120° F.

FIG. 3A is an unmagnified photograph of a cross-sectional view of a pancake component removed from a cooking surface when the center of the top surface reached a temperature of about 140° F.

FIG. 3B is a photograph of a top surface view of a pancake component removed from a cooking surface when the center of the top surface reached a temperature of about 140° F.

FIG. 3C is a microscopy image of a pancake component that was removed from a cooking surface when the center to the top surface reached a temperature of about 140° F.

FIG. 3D is a 11.5× magnification photograph of a cross-sectional view of a pancake component removed from a cooking surface when the center of the top surface reached a temperature of about 140° F.

FIG. 4A is an unmagnified photograph of a cross-sectional view of a pancake component removed from a cooking surface when the center of the top surface reached a temperature of about 160° F.

FIG. 4B is a photograph of a top surface view of a pancake component removed from a cooking surface when the center of the top surface reached a temperature of about 160° F.

FIG. 4C is a microscopy image of a pancake component that was removed from a cooking surface when the center of the top surface reached a temperature of about 160° F.

FIG. 4D is a 11.5× magnification photograph of a cross-sectional view of a pancake component removed from a cooking surface when the center of the top surface reached a temperature of about 160° F.

FIG. 5A is an unmagnified photograph of a cross-sectional view of a pancake component removed from a cooking surface when the center of the top surface reached a temperature of about 180° F.

FIG. 5B is a photograph of a top surface view of a pancake component removed from a cooking surface when the center of the top surface reached a temperature of about 180° F.

FIG. 5C is a microscopy image of a pancake component that was removed from a cooking surface when the center of the top surface reached a temperature of about 180° F.

FIG. 5D is a 11.5× magnification photograph of a cross-sectional view of a pancake component removed from a cooking surface when the center of the top surface reached a temperature of about 180° F.

FIG. 6A is an unmagnified photograph of a cross-sectional view of a pancake component removed from a cooking surface when the pancake component was completely cooked.

FIG. 6B is a photograph of a top surface view of a pancake component removed from a cooking surface when the pancake component was completely cooked.

FIG. 6C is a microscopy image of a pancake component that was removed from a cooking surface when the pancake component was completely cooked.

FIG. 6D is a 11.5× magnification photograph of a cross-sectional view of a pancake component removed from a cooking surface when the pancake component was completely cooked.

FIG. 7 is a photograph of a cross sectional view of the two halves of a cooked filled pancake.

### DETAILED DESCRIPTION OF THE PREFERRED EMBODIMENTS

It has been discovered that batter-derived food products with filling can be made by depositing the filling prior to complete gelatinization of the batter. A food product, particularly a pancake, can be made that has a filling completely encased within gelatinized batter. In particular, the filled food product contains a food structure that includes cooked, hydrated flour that is continuous and surrounds the filling.

The food structure of the filled food products described herein include a spongy, short and tender structure referred to herein as the “spongy structure”. Short and tender refers to food products that are porous with an aerated structure and a continuous cell network characteristic of batter-derived food products. The spongy structure generally can be ripped apart more easily than typical dough-derived food products since the spongy structure has little or no elasticity. Food products with the spongy structure generally have a lower level of gluten development than dough products.

The spongy structure is generally found in food products that are made from batter, i.e. batter-derived food products. Batter, in contrast with a dough, has a high water content and can have moderate to low viscosity such that the batter spreads when applied to a cooking surface. The filled products described herein also include a filling that is encased within the spongy food structure.

The filled food products described herein preferably are fully cooked. By fully cooked, it is meant that substantially all of the batter in the product has been gelatinized and that the product has achieved a desirable golden brown color on the surface. The starch granules in the batters described herein can be either in the gelatinized state or the ungelatinized state during the cooking process. As the batter is cooked, the batter becomes set and begins to acquire the spongy structure. In addition, the starch granules in the batter start to gelatinize. As the starch granules gelatinize, the batter appears wet and flowable and can become sticky. When substantially all of the starch granules gelatinize, the wet and flowable appearance on the surface is replaced by a spongy structure that is drier and therefore, not sticky.

The spongy structure of the cooked filled food products generally has a high moisture content. The moisture content of the batter-derived portion of the food products is generally at least about 20 percent by weight, preferably between about 25 percent by weight and about 60 percent by weight. The filled food products can be any number of batter-derived products including, for example, pancakes, waffles, muffins, and cakes. In particular, the filled food product can appear to be a single, continuous structure that completely surrounds the filling with gelatinized batter rather than two components that were combined as in a sandwich.

The filled food products described herein are generally made by generating a partially cooked food component from the batter and depositing the filling on the ungelatinized surface of the partially cooked food component. The partially cooked food component may then be combined with another partially cooked food component and further heated to produce a sealed, fully cooked food product with the spongy structure and the filling encased within the spongy structure. The overlapping ungelatinized surfaces form a seamless cooked structure sealing the filling within the product. Alternatively, the filling may be deposited in a partially cooked food component that has been cooked with heat applied on the top surface and the bottom surface. After an initial cooking period during which sufficient spongy structure forms at the bottom to hold the filling, but where the center still includes ungelatinized batter, the filling is deposited. The partially cooked food component with the filling is further heated to generate the fully cooked food product.

In some embodiments, the filled food products are filled pancakes. The filled pancakes are generally produced by depositing two aliquots of batter on a cooking surface. The batter has a fluid consistency such that it spreads to a reasonable thickness on the cooking surface. The two aliquots of batter preferably contain similar amounts of batter and more preferably about equal amounts of batter. The aliquots of batter are heated for an appropriate length of time to form partially cooked pancake components.

Partially cooked pancake components will be referred to herein as pancake components. Pancake components appropriate for use in the methods described herein generally have sufficient spongy structure in the center such that the batter is not runny when the pancake component is flipped over. In addition, the structure of the pancake component generally is sufficiently set to hold the filling without appreciable sinking.

Pancake components appropriate for making the filled pancakes described herein generally have edges that are sticky due to gelatinization of only some of the starch granules in the pancake component. In particular, the top surface of the pancake component edges can appear wet and flowable when sufficiently sticky. Preferably the pancake components are cooked until the edges of the top surface are about 140° F. Dry or spongy edges on pancake components generally will result in defective filled pancake products due to inappropriate sealing.

Gelatinization of the batter generally occurs sequentially from the bottom, closest to the cooking surface, to the top. The partially cooked pancake components thus, include a bottom layer with a spongy structure and a top surface that is mostly ungelatinized and sticky, particularly at the edges.

A filling can be deposited on the ungelatinized surface of one or optionally both of the pancake components. Pancake components without an appropriate amount of heating may not contain an appropriate amount of the spongy structure to support the filling. The pancake component preferably contains an appropriate spongy structure that can hold the filling without allowing the filling to sink to the bottom. Inappropriate amount of the spongy structure when the filling is deposited can lead to a food product that may have a filling that is too close to the surface and therefore, visible to at least one of the surfaces. After deposition of the filling, the two pancake components are then combined such that the ungelatinized surfaces contact each other to form a combined pancake composition.

The combined pancake composition is generally heated further to gelatinize a significant amount of the remaining batter and bond the edges of the composition. Preferably, the combined composition is heated until substantially all of the batter of the combined composition gelatinizes and forms a continuous spongy structure around the filling. Heating of the combined pancake composition thus, produces a filled pancake product that has a filling encased within it.

In preferred embodiments, the filled pancakes described herein are made with a batter of slightly lower viscosity than conventional pancake batters. The viscosity of a given amount of batter can determine the thickness and diameter of the pancake component since, for example, a less viscous batter spreads to form a larger diameter, thinner structure. The lower viscosity batter generates the appropriate surface-to-volume ratio, particularly for making the desirable pancake components. In preferred embodiments, the two pancake components are thinner than a traditional pancake because a filled pancake with a thickness similar to a traditional pancake is desirable to consumers. In other words, the lower viscosity leads to thinner pancake components such that the filled pancake product has a desired total thickness. In some embodiments, filled pancake products that are thicker than traditional pancakes may be desirable.

A particular advantage of the filled food products described herein for the consumer is the ease of preparing and consuming these filled food products. In convenient embodiments, the filled food products can be distributed in a frozen form to the consumers. The frozen filled food product can be reheated in a microwave oven without any leakage since the filling is encased within the food product. The consumer does not need to supply any additional topping since the filling is already within the food product. Furthermore, the filled food products, particularly the filled pancakes, can be consumed even by children, without a large mess usually associated with traditional pancakes and topping. Packaging of the filled pancakes in particular is similar to the packaging of traditional unfilled frozen pancakes.

Batter

Batter used to make the food products described herein is generally a composition of dry ingredients and liquid ingredients that have been combined together to produce a batter with a desired viscosity. Dry ingredients can include, for example, flour, leavening agents, sweeteners, dried egg products and dried dairy products. Liquid ingredients can include for example, water, milk, oil, eggs, liquid sweeteners and the like. Some of the batter components may be added either in the dried form or the liquid form. Milk and eggs for example, may be added in the liquid form or alternatively substituted with dried milk product or dried egg product, respectively.

The batter minimally includes flour and a liquid ingredient. Suitable flours include glutinous flours, nonglutenous flours and combinations thereof. If nonglutenous flour is used, a sufficient amount of glutinous flour, gluten, and/or gluten-by-products may be included in the batter. Preferred flours include, for example, wheat, corn, rye, barley, oats, sorghum and tritiacale. The flours can be whole grain flours, flours with the bran and/or germ removed, or combinations thereof. Generally, the batter includes at least about 20 percent by weight flour, preferably from about 25 percent to about 36 percent by weight flour, and more preferably from about 27 percent to about 33 percent by weight flour.

The batter can also include one or more liquid ingredients. Suitable liquid ingredients include for example, water, milk, liquid eggs, sweeteners, other liquid milk products and oil. If a plurality of liquid ingredients are used, suitable combinations include, for example, oil/milk, oil/water and the like. The dry ingredients can generally be added to the liquid ingredients. The amount of liquid ingredients used is dependent on the desired viscosity of the batter. Generally the viscosity of the batter decreases with increasing amounts of liquid ingredients.

The total amount of liquid ingredients to make batters described herein is generally between about 35 percent by weight and about 75 percent by weight, preferably between about 40 percent by weight and about 75 percent by weight, and more preferably between about 46 percent by weight and about 70 percent by weight.

The batter can also include egg products. Suitable egg products include for example, fresh eggs, egg substitutes, dried egg products, frozen egg products. The egg products may be in a dried form or a liquid form. In preferred embodiments, the batter comprises between about 6 percent by weight and about 20 percent by weight of egg product. In more preferred embodiments, the batter comprises between about 11 percent by weight and about 16 percent by weight of egg product. If fresh or other liquid egg products are used, the amount of other liquid ingredients are adjusted to compensate for the liquid form of eggs.

The batter can optionally include dairy products. Suitable diary products include, for example, milk, buttermilk and other milk products. Additionally, milk substitutes such as soy milk may also be used. In preferred embodiments, the batter comprises between about 30 percent by weight and about 60 percent by weight of dairy products. In more preferred embodiments, the batter comprises between about 40 percent by weight and about 55 percent by weight of dairy products.

The dairy products may be added in a liquid form or in a dried form. Liquid milk can be added during preparation of the batter. If liquid dairy products, such as milk, are used, they may be the only liquid ingredient. Alternatively, the liquid dairy component may be used along with another liquid ingredient in appropriate amounts described for the liquid ingredients above. Alternatively, dried milk products may also be used during batter preparation. If dried milk products are used, the total amount of liquid ingredients is adjusted to obtain the desired viscosity. Generally, if dried milk products are used, the amount of water used in the batter preparation is increased.

The batter, optionally, can include fat components. Preferred fat components include, for example, oil, butter and shortening. Suitable oils include, for example, soy bean oil, corn oil, canola oil, sunflower oil and other vegetable oils. Suitable shortenings include, for example, animal fats and hydrogenated vegetable oils. In preferred embodiments, the batter includes less than about 10 percent by weight fat and more preferably from about 5 percent by weight to about 2 percent by weight fat.

As noted above, the dry ingredients can include a leavening agent. The leavening agent in the batter can include a carbonate and/or bicarbonate salt and a leavening food acid. Suitable carbonate and bicarbonate salts include, for example sodium carbonate, potassium carbonate, sodium bicarbonate, potassium bicarbonate, ammonium bicarbonate and mixtures thereof. A variety of leavening acids are suitable, including conventional leavening acids known in the industry. Suitable leavening acids include, for example, citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), glucono delta lactone (GDL) and mixtures thereof. Preferably, the leavening acids are MCP and SALP. Following completion of the leavening process, the anion of the leavening acid and the cation of the soda generally remain in the batter as a by-product of the chemical leavener. When a leavener is included, the batter preferably comprises between about 0.25 percent by weight and about 2.0 percent by weight of leavening agents and more preferably between about 1.0 percent by weight and about 2.0 percent by weight of leavening agent.

Furthermore, the batter can include, optionally, a sweetener and/or artificial sweetener. Suitable sweeteners include dry sweeteners and liquid sweeteners. Suitable dry sweeteners include, for example, lactose, sucrose, fructose, dextrose, maltose, corresponding sugar alcohols, and mixtures thereof. Suitable liquid sweeteners include, for example, corn syrup, malt and hydrolyzed corn syrup. Liquid sweeteners include water that can contribute to the total quantity of liquid ingredients. In preferred embodiments, the batter includes from about 0.5 percent by weight to about 10 percent by weight sweetener.

The batter can further include additional flavorings including, for example, salt, such as sodium chloride and potassium chloride, whey, malt, yeast extract, inactivated yeast, spices and vanilla. The additional flavoring preferably comprise from about 0.1 percent by weight to about 5 percent by weight of the batter. And more preferably from about 0.2 percent by weight to about 3 percent by weight of the batter. Similarly, the batter can include particulate ingredients intermixed in the batter such as nuts, flavor chips, seeds, fruit bits and the like. Particulate ingredients, if added, can be generally between about 0.1 percent by weight and about 15 percent by weight, preferably between about 1 percent by weight and about 10 percent by weight.

The batter may also include emulsifiers to stabilize the air cell structure. Suitable emulsifiers include for example, diacetyl tartaric acid ester of mono-diglycerides (DATEM), mono and diglycerides of fatty acids, glycerol-lacto esters of fatty acids, sodium stearoyl lactylate (SSL), lecithin and mixtures thereof. The batter may also include conditioners. The conditioners are used particularly in the absence of egg products. Suitable conditioners include for example, potassium sulfate, L-cystine and sodium bisulfate.

The batter is generally prepared by combining the flour and any other dry ingredients with the liquid ingredients. The dry ingredients are generally mixed for even dispersion prior to combination with the liquid ingredients.

The appropriate quantities of dry ingredients are generally placed in a vessel such as a bowl and mixed. A number of implements are suitable for mixing the dry ingredients including for example, a ribbon blender, a spoon and a spatula. The dry ingredients are generally mixed until they are substantially evenly dispersed. Preferably the ingredients are mixed in a ribbon blender between about 5 minutes and about 15 minutes.

The liquid ingredients are generally added to a mixing vessel followed by the addition of dry ingredients. The contents of the mixer generally are mixed while the dry ingredients are being added to the mixer. Suitable mixing vessels for mixing liquid ingredients and dry ingredients include bowls and tanks. The size of mixing vessel is determined by the quantity of batter to be processed. Suitable implements for mixing include, for example, paddles, spoons, whisks and impellers.

The liquid ingredients and the dry ingredients may be mixed in a big tank and agitated. Agitation can be at moderate speed with high shear. Suitable mixing apparatus include for example, a baffled tank with a Lightnin agitator obtained from Lightnin Mixers Rochester, N.Y. and a Breddo Likwifier obtained from Breddo, Div. Of American Ingredients Co. Kansas City, Mo. The mixing is generally performed between about 3 minutes and about 15 minutes, preferably between about 5 minutes and 10 minutes.

The liquid ingredients and the dry ingredients can be mixed until substantially all the dry and liquid ingredients are evenly dispersed to form a substantially smooth batter. Some lumps, pockets of dry ingredients, may persist in the batter. The batter is appropriate for use even in the presence of some small lumps. However, the presence of lumps may decrease the desirableness of the final product. The batter preferably is not overmixed. The batter, once prepared, can be used immediately. Alternatively, the batter preferably is used within about 2 hours from the time of preparation. Batter that has been mixed more than about 2 hours prior to use may not generate a preferred food product.

The batters described herein generally have a high moisture content. The moisture content of the batter can be between about 20 percent by weight to about 60 percent by weight. Preferably the moisture content of the batter is between about 35 percent by weight and about 55 percent by weight and more preferably between about 45 percent weight and 55 percent by weight.

In embodiments for making filled pancakes, the moisture content of the batter is preferably between about 40 percent by weight and about 55 percent by weight and more preferably between about 45 percent by weight and about 53 percent by weight.

The viscosity of the batter for making the filled pancakes described herein is generally lower than the viscosity of conventional pancake batters, particularly to achieve a filled pancake thickness that is about the same thickness as conventional unfilled pancakes. Pancake batters described herein have a viscosity generally of less than about 16,000 centipoise (cps) at a shear rate of 20 rpm. Preferably, the viscosity at a shear rate of 20 rpm is between about 16,000 cps and about 1000 cps. More preferably, the viscosity at a shear rate of 20 rpm is between about 15,000 cps to about 1500 cps. Even more preferably, the viscosity at a shear rate of 20 rpm is between about 12,000 and about 2000.

The viscosity of batters can be decreased by increasing the amount of liquid ingredients or by decreasing the amount of dry ingredients. However, if the viscosity of the batter is too low, the surface-to-volume ratio can be too high, i.e. the pancake component is too thin. A high surface-to-volume ratio can produce a pancake component that gelatinizes too quickly and does not allow enough time for filling deposition before losing stickiness. In addition, it can not support much filling.

If the viscosity of the batter is high, the surface-to-volume ratio of the pancake can be too low, i.e. the pancake component is undesirably thick. Thus, the bottom surface of a pancake component may burn before the batter structure in the center sets appropriately. A pancake component that is undesirably thick may also result in batter spillage when one of the pancake components is combined with another pancake component.

The diameter of the pancake can also be important. A pancake that is too large can result in dry, insufficiently sticky edges, with a center that may not be structurally set enough to flip successfully. Alternatively, a pancake that is too small may not hold a desirable amount of filling.

The thickness of each of the pancake components is generally between about 4 millimeters (mm) and about 10 mm, preferably between about 5 mm and about 9 mm and more preferably between about 5.5 mm and about 7.5 mm.

The thickness of the filled pancake is generally between about 8 mm and about 20 mm, preferably between about 10 mm and about 18 mm and more preferably between about 11 mm and about 15 mm.

Filling

The filling for the pancakes described herein can be a raw or cooked food product. The filling and/or ingredients of the filling can be previously frozen and subsequently thawed and/or cooked. The filling can have a uniform consistency or a chunky consistency. In preferred embodiments, the filling is a highly viscous liquid, suspension or pseudoliquid, i.e., a flowable mixture of particulates and/or liquid that may not formally be a liquid or a suspension. The material preferably is highly viscous such that it will not flow immediately off the surface of the pancake component or through any imperfection in the filled pancake.

The filling can be made from any type or types of food ingredients, including meat ingredients, vegetable ingredients, dairy ingredients, fruit ingredients, spices, flavorings, fats and the like. The filling can further include, for example, preservatives and property modifiers, such as emulsifiers and thickening agents. Suitable thickening agents include for example, starches and gums.

A fruit filling is preferable in some embodiments. Suitable fruit fillings include for example grape filling, strawberry filling, raspberry filling, cinnamon filling, maple syrup filling, cherry filling, blueberry filling, or the like. Fruit fillings can include fruit components in the form of pieces, jelly, juice, flavorings and the like. The fruit filling generally comprises fruit components, sweeteners, water, thickening agents, and flavors. There is no specific limitation on many of the ingredients of the filling composition, each of the ingredients being used to develop the desired sweetness-tartness combination one chooses as well as the specific flavors. In preferred embodiments, a wide variety of fruit jellies and flavors are used as the fruit filling.

Fruit fillings for breakfast pastries for example, are described in U.S. Pat. No. 4,612,198 which is incorporated herein by reference. These fillings while having the same ingredients may have different preferred properties than the filling desirable in the food products described herein. The fillings for the improved batter based products described herein preferably have a water activity between about 0.85 and 0.9. Water activity can be determined as a_{w}=p/pₒ=ERH/100, where p is the partial pressure of water above a sample, p^{o} is the vapor pressure of pure water at the same temperature, ERH is the equilibrated relative humidity (%) surrounding the product. A lower water activity filling can also have high bake stability and thus, longer shelf life. A filling with high water activity can cause moisture migration to the crust and result in a soggy food product, thus compromising the product quality.

The fillings used in the filled food products described herein generally have a viscosity necessary to stay in place following deposition and during the cooking process. The viscosity of the filling is generally within the range of from about 175,000 cps to about 350,000 cps, preferably from about 200,000 cps to about 300,000 cps, and most preferably from about 220,000 cps to about 280,000 cps.

Preferable fillings can maintain their viscositites with small or no changes during the cooking process. The viscosity of a filling, particularly the propensity of the filling to stay in place when deposited and the propensity of the filling to boil out during cooking, can be influenced by the types of starch components that are present in the filling. In particular, pregelatinized starches can control the viscosity of a filling during placement on the pancake component. Cook-up starches, on the other hand, can control the viscosity during the heating process.

The desired viscosity ranges of the filling composition can be accomplished by controlling the amount of starch, gum and fruit solids to achieve the specified viscosity ranges and the desired attributes. Preferably, the total starch ranges are between about 4.0 percent by weight to about 10 percent by weight of the filling, more preferably, from about 6 percent by weight of the filling to about 8 percent by weight and most preferably from about 6.5 percent by weight to about 7.5 percent by weight.

In addition to starches, gums such as gellan gum, xanthan gum, guar gum and locust bean gum may also be employed to achieve the desired viscosity in the filling. The gum level, preferably is between about 0.2 percent by weight and about 0.8 percent by weight. More preferable are gum ranges between about 0.4 percent by weight and 0.6 percent by weight.

In addition to viscosity, the pH range of the filling may also be adjusted, particularly in fruit fillings. In non-fruit fillings, the pH may vary over a range of from about 2.8 to about 7.5. Fruit fillings and other acidic type fillings generally have a pH between about 3.0 to about 5.0, preferably between about 3.2 to about 4.7 and more preferably between about 3.5 to about 4.1.

Process of Making Filled Food Products

The filled food products described herein are generally made by generating a partially cooked component from the batter and depositing the filling on the partially cooked component. The partially cooked component may then be combined with another partially cooked component and further heated to produce a fully cooked food product with the spongy structure and the filling encased within it. Alternatively, the filling may be deposited in a partially cooked component that has been cooked with heat applied on the top surface and the bottom surface. After an initial cooking period during which sufficient spongy structure forms at the bottom to hold the filling, but where the center still includes ungelatinized batter, the filling is deposited. The partially cooked component with the filling is further heated to generate the food product.

A filled pancake can be made by aliquoting and heating two portions of batter to form two pancake components. A filling is deposited on one or both of the pancake components. The two pancake components are then combined to form a combined pancake composition that contains the filling surrounded by sufficiently ungelatinized batter such that the batter along the edges can combine between the pancake components. The combined pancake composition is further heated to produce a filled pancake product with sealed edges and substantially gelatinized batter around the filling.

To form the pancake components, the pancake batter described herein can be generally deposited onto a cooking surface. In preferred embodiments, the filled pancake products described herein generally include between about 40 grams and about 120 grams of batter, preferably, between about 50 grams and about 110 grams of batter and more preferably, between about 60 grams and about 100 grams of batter. The batter generally is about equally divided to form the two pancake components that are combined with the filling to form the filled pancake composition.

In some embodiments, the batter can be spot-deposited onto the cooking surface using any suitable implement. The depositor preferably can deposit approximately the same predetermined amount of batter each time. Suitable depositors include, for example, a vessel containing an aliquoting mechanism such as cups, spoons, or the like. Preferably a piston depositor apparatus is used. Piston depositors can be obtained from a number of commercial sources.

Cooking surfaces for making the pancakes described herein are generally flat. A griddle for example, contains an appropriate flat cooking surface. Instead of a flat surface, the cooking surface may also include templates of various shapes such as squares, triangles or animal shapes. Alternatively, the griddle may contain a number of protrusions, commonly associated with a waffle griddle.

Cooking surfaces can include metals, for example, cast iron, aluminum, and non-stick surfaces such as teflon. The cooking surface may be additionally treated with a non-stick substance that prevents the pancake from sticking to the cooking surface. The use of a non-stick cooking surface may alleviate the need to use a non-stick substance. Suitable non-stick substances include, for example, butter, oil, non-stick sprays and the like. The non-stick substance, when used, is generally applied to the cooking surface prior to deposition of the pancake batter.

The cooking surface is generally preheated to a selected temperature. Generally, the cooking surface is preheated at a setting of between about 325° F. and about 500° F. and preferably between about 350° F. and about 450° F. and more preferably about 400“F. Two aliquots of pancake batter are generally deposited on one or more preheated cooking surfaces and heated appropriately to produce partially cooked pancake components. The aliquots of batter on the cooking surface are generally heated between about 40 seconds to about 100 seconds to produce the pancake components. Preferably, the batter is heated between about 75 seconds to about 85 seconds when the griddle setting at about 400° F. More preferably the batter is heated between about 78 seconds and about 82 seconds when the griddle setting is at about 400° F.

The two aliquots of batter deposited on the cooking surface are generally heated until a bottom spongy structure has formed without the loss of edge stickiness. The two aliquots of batter are generally heated until the top surface temperature at the edges of the pancake components is between about 120° F. and about 155° F., preferably between about 125° F. and about 150° F. and more preferably between about 130° F. and about 145° F.

The extent of gelatinization can also be used as an indicator of appropriate cooked pancake components. The extent of gelatinization can be measured using electron microscopy with light refraction as described below in Example 3. The two aliquots of batter are generally heated until between about an eighth of the batter and about half of the batter is gelatinized using an electron microscopy analysis, preferably about a quarter of the batter is gelatinized.

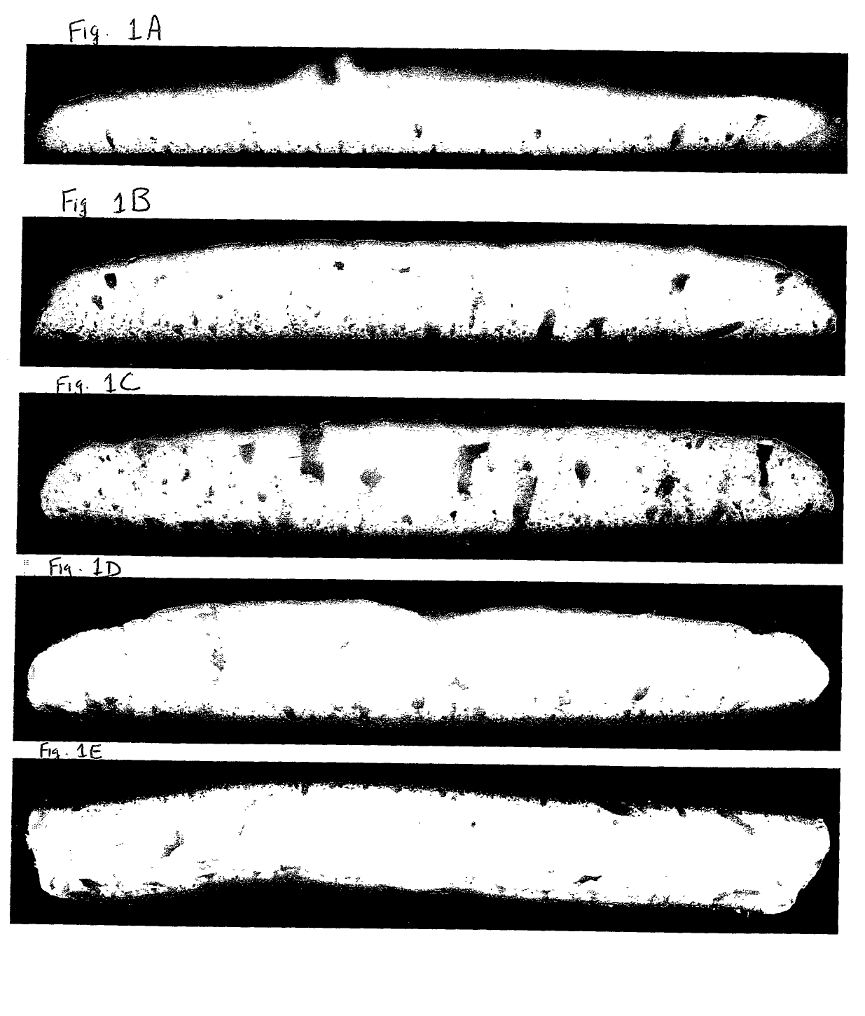

FIG. 1 is a photograph that shows the appearance of pancake components at various surface temperatures. FIG. 1A, 1B, 1C, 1D, and 1E show a cross section of pancake components at a temperature at the center of the top surface, of about 120° F., 140° F., 160° F., 180° F. and fully cooked, respectively. FIG. 1B, for example, illustrates the structure of the pancake component at a center top surface temperature of about 140° F., a preferable temperature at the edges of the pancake component. The temperature at the edges of the top surface is generally higher than the temperature at the center of the top surface. In cross-sections, the structure at the edges of the pancake components preferably are similar to the structure at the center of the pancake component shown in FIG. 1B. A pancake component with edges having a structure as in the center of the pancake component in FIG. 1C may have edges that are not sufficiently sticky and that may not seal properly when combined with another pancake component. Starch generally gelatinizes in the presence of water at about 140° F. When the edges of the top surface are about 140° F., the pancake components are generally sticky enough that when two ungelatinized layers of two pancake components are combined, bonding can still occur and the two layers form a continuous unit. The pancakes are generally completely cooked when the starch, throughout the pancake, has gelatinized, as shown in FIG. 1E.

A filling is generally deposited on the ungelatinized top surface of one of the two pancake components. In some embodiments, filling may be deposited on both of the pancake components. The filling can be deposited in a variety of ways. Suitable methods for depositing filling include, for example, the use of a spoon, a cup, a syringe, a piston depositor and the like. A method for aliquoting the filling is generally chosen such that each set of pancakes receives about the same amount of filling. Generally, at least about 2 grams of filling is deposited on a pancake component. Preferably, about 5 to about 15 grams of filling is deposited on a pancake component. More preferably, about 8 to 12 grams of filling is deposited on a pancake component.

Premature depositing of the filling can result in the filling sinking into the pancake batter. In such instances, the filling can become visible at one of the surfaces in the cooked food product because the filling is too close to the surface. If the filling sinks significantly into the batter, the pancake generally has not achieved the sufficient spongy structure necessary to support the weight of the filling. Additionally, the batter of the pancake components would not be appropriately set and could result in spillage of batter from the surface of the flipped pancake component during combining of the pancake components.

Delay of the filling deposition until the edges of the top surface are inappropriately sticky results in a pancake sandwich with exposed filling in the middle rather than a filled pancake with a single, continuous spongy structure with the filling encased within it. The wet, batter-like consistency of the top layer, especially at the edges, that is particularly advantageous for joining the ungelatinized surfaces of the pancake components can be gone. In these circumstances, appropriate bonding may not occur when the two pancake components are combined. The filling thus, does not become sealed within the food product. In such instances, the filling may be visible from the sides and may potentially leak out from the sides of the filled food product.

After the filling has been deposited, the two pancake components are combined such that the substantially ungelatinized layers of the two pancake component surfaces interact and result in a combined pancake composition. The two pancake components are generally combined by lifting one of the pancake components off the cooking surface and contacting the ungelatinized surface of this pancake component with the ungelatinized surface of the pancake component that is still on the cooking surface. The new top surface of the combined composition, initially, is the bottom, gelatinized surface of the pancake component that was lifted off the cooking surface. The ungelatinized portions of the two pancake components can have sufficient surface-to-surface interactions that the two pancake components stick together and bond upon further heating.

In some embodiments, the two pancake components can be combined by lifting the pancake component with the filling and placing it onto the top of the pancake component without the filling. In preferred embodiments, the two pancake components are combined by placing the pancake component without the filling onto the top of the pancake component with the filling such that the two ungelatinized surfaces interact.

In other embodiments, both of the pancake components can have fillings deposited on them and either of the pancake components can be lifted from the cooking surface and placed on the other pancake component. Preferably, the pancake component with the more viscous filling is lifted off the cooking surface and placed on the other pancake component with the less viscous filling.

The combined pancake composition can be further heated in order to bond the edges and further gelatinize the remaining batter. Preferably, the combined pancake composition is heated until substantially all the batter is gelatinized. In order to gelatinize substantially all the batter without overheating or burning the combined pancake composition, the combined pancake composition is generally heated on one side, flipped over and heated further. The combined pancake composition may be heated on a cooking surface as the pancake components. Alternatively, the combined pancake composition may be heated using other methods including microwave heating, conventional oven heating and the like.

Preferably, the combined composition is heated between about 30 seconds and about 90 seconds following contacting the two ungelatinized surfaces. More preferably, the combined composition is heated between about 45 seconds and about 75 seconds at a griddle setting of about 400° F. The combined composition, when heated appropriately to complete the gelatinization of the batter, generates a filled pancake with a continuous spongy structure such that the filled pancake resembles a single pancake structure rather than two separate pancakes.

The fully cooked, batter-derived portion of the filled food products can have a moisture content of at least 20 percent by weight, preferably between about 25 percent by weight and about 60 percent by weight, more preferably between about 30 percent by weight and about 55 percent by weight and even more preferably between about 45 percent by weight and about 55 percent by weight.

In embodiments of filled pancakes, the moisture content of the batter-derived portion of the filled pancake is preferably between about 35 percent by weight and about 55 percent by weight, more preferably between about 40 percent by weight and about 50 percent by weight.

The diameter of the filled pancakes described herein generally ranges between about 2.0 inches to about 5.0 inches. Preferably the diameter of the filled pancake is between about 2.5 inches and about 4.5 inches. More preferably, the diameter of the filled pancake is between about 3.0 inches and about 4.0 inches.

An appropriate pancake diameter generally tends to encourage a substantially uniform degree of starch nongelatinization in the top layer of the pancake components during the initial heating. Pancakes with diameters that are too large can have pancake components with edges that become gelatinized by the time the majority of the center structure is set appropriately such that the batter will not spill out when the pancake component is lifted off and combined with another pancake component. On the other hand, the filling may not be appropriately encased in the filled pancakes that have large diameters because appropriate center pancake structure may not be formed when the edges are appropriately sticky. If the diameter is too small, the filled pancake may not contain a desirable amount of filling.

A more uniform degree of starch nongelatinization may also be encouraged by adjusting the temperature appropriately. In particular, heating the batter at lower temperatures may encourage a more uniform nongelatinization in the top layer.

The surface-to-volume ratio of the filled pancake can be significant in minimizing edge effects, i.e. stickiness of edges. Surface-to-volume ratio is dependent on the diameter and the thickness of the pancake product. Preferably, the filled pancakes are between about 2.5 inches and about 4.5 inches in diameter and between about 8 millimeters (mm) and about 20 mm in thickness. More preferably, the filled pancakes are between about 3.0 to about 4.0 inches in diameter and between about 10 mm to about 15 mm in thickness.

The filled pancake can generally be removed from the cooking surface once the filling is encased within the pancake. Preferably, the filled pancake is removed from the cooking surface when the filling is encased within the pancake and substantally all of the batter has gelatinized around the filling.

Following removal from the cooking surface, the filled pancake is suitable for consumption, if desired, or for storage. Storage generally involves refrigerating or freezing the product. Refrigerated or frozen filled pancake products can be stored for reasonable periods of time based on the storage temperatures. The refrigerated or frozen product can be reheated prior to eating, if desired.

The frozen or refrigerated filled pancake can be packaged for distribution to the consumer. Any suitable packaging can be used including conventional packaging. The consumer generally reheats the filled pancake by baking or microwave heating the product. The filled pancakes described herein are particularly amenable to microwave heating. Microwave cooking is a desirable approach from a consumer perspective due to convenience and speed.

### EXAMPLES

### Example 1

### Batter Formulations

This example illustrates three different formulations of batters for the formation of pancakes. The viscosities of the batters and the characteristics of the resulting unfilled pancakes are analyzed.

Three different batters were prepared with the ingredient amounts indicated in Table 1. The batters were made by mixing the pre-blended dry ingredients into a mixture of the liquid ingredients, i.e., eggs, oil and milk. The batter was mixed with a Lightnin” agitator supplied by Lightnin Mixers, Rochester, N.Y. The batter was mixed for about 5 minutes using the agitator at moderate speed. The viscosity of the batters were measured with a Brookfield viscometer using a shear rate of 20 rpm. To calculate the viscosity, the power law equation ETA=KxDⁿ⁻¹ (where D is assumed at 2 rpm) was used. In the power law equation, ETA is viscosity at a selected shear rate, K is the viscosity constant, n is the shear dependency and D is the shear rate.

To form each pancake, about 30 g of batter was aliquoted onto a griddle that was set at about 400° F. The pancakes were heated for about 80 seconds, turned over and heated for about another 30 seconds. These pancakes were then evaluated. The results of the evaluation are shown in Table 1.

The moisture content of the pancakes was also determined by weighing a portion of a fully cooked pancake, drying the portion until the moisture has evaporated, and weighing the dried portion. The difference in weight between the fully cooked pancake and the dried pancake is the weight of the moisture and can be used to determine the moisture content of the pancake.

As shown in Table 1 and Table 2, batter 2 with a viscosity of 3494 cps measured at a shear rate of 20 rpm resulted in a pancake with a desirable thickness. When the viscosity is too high as in batter 1, the filled pancake was undesirably thick in comparison to a conventional pancake and dense. Burning on the bottom surface occurred prior to setting of the structure. Alternatively, when the viscosity of the batter is too low as in batter 3, the pancakes are undesirably soft and thin to manipulate.

TABLE 1

| | BATTER 1 | | BATTER 2 | | BATTER 3 | |
|---|---|---|---|---|---|---|
| | Weight | Weight | Weight | Weight | weight | Weight |
| | (g) | % | (g) | % | (g) | % |
| flour | 247 | 35.57 | 35.57 | 28.45 | 28.45 | 25.85 |
| bp | 13 | 1.87 | 1.87 | 1.50 | 1.5 | 1.36 |
| salt | 3 | 0.43 | 0.43 | 0.34 | 0.34 | 0.31 |
| Sugar | 55 | 7.92 | 7.92 | 6.34 | 6.3 | 5.72 |
| Eggs | 108 | 15.55 | 15.55 | 12.44 | 12.5 | 11.36 |
| Oil | 25.5 | 3.67 | 3.67 | 2.94 | 2.96 | 2.69 |
| Milk | 243 | 34.99 | 60 | 48.00 | 58 | 52.70 |
| TOTAL | 694.5 | 100.0 | 125.01 | 100.0 | 110.05 | 100.0 |
| fried mm | | 9 | | 6 | | 5 |
| thickness | | | | | | |

| | | | |
|---|---|---|---|
| Comments | Thick/dense | Ok | very soft |
| Viscosity | 16301 | 3494 | 1094 |

TABLE 2

| | K | D | n | n-1 | Viscosity |
|---|---|---|---|---|---|
| Batter 1 | 35747 | 4.4 | 0.47 | −0.53 | 16301 |
| Batter 2 | 5697 | 4.4 | 0.67 | −0.33 | 3494 |
| Batter 3 | 1564 | 4.4 | 0.76 | −0.24 | 1096 |

Table 3 shows the results from the moisture content analysis of pancakes derived from batters 1 and 3.

TABLE 3

| | % Moisture content | % Moisture content |
|---|---|---|
| | (batter) | (cooked pancake) |
| Batter 1 | 47.84 | 42.87 |
| Batter 2 | 52 | 47.47 |

### Example 2

### Method for Making a Filled Pancake

This example demonstrates a method for making a filled pancake from a batter.

Batter 2 described in Example 1 was used for this example. Two 30 gram aliquots of pancake batter were deposited on a griddle and the batter was allowed to spread naturally. The griddle was set at about 400° F. The two aliquots of batter were cooked for about 80 seconds to form two pancake components. A blueberry filling of about 10 grams was placed in the center of one of the pancake components with a pastry bag equipped with a cake decorating nozzle. The other pancake component, without the filling, was lifted from the griddle, flipped and placed onto the pancake component with the filling such that the two ungelatinized surface layers interacted. The combined composition was heated for about 30 seconds. Then, the combined composition was flipped over and heated for about another 30 seconds.

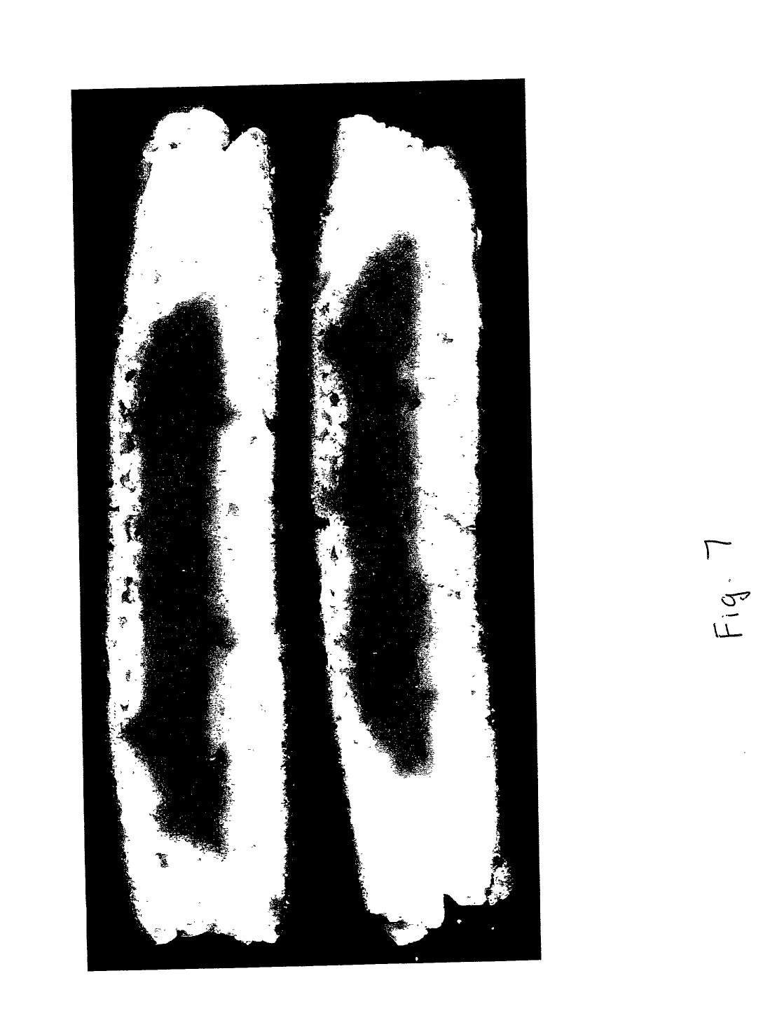

Preparation of the filled pancake in this manner resulted in a pancake with a light brown color that was fully cooked as shown in FIG. 7.

### Example 3

### Surface Characteristics of the Pancake Components

This example examines the surface characteristics of the pancake components. The changes in surface characteristics with changing surface temperatures is also determined.

Pancakes were made using batter 2 of Example 1. To form pancake components, about 30 g aliquots of batter was deposited on a griddle set at about 400° F. The pancakes were removed at different amounts of cooking and analyzed. These cooking times were reached when the center of the top surface of the pancakes reached a temperature of 120° F., 140° F., 160° F., 180° F., and completely done. When the center of the top surface of the pancakes reached the respective temperature the pancakes were removed from the griddle and frozen. A cross-section of the frozen pancakes was cut and analyzed. The cross-sections of the pancakes were also analyzed using microscopy. Microscopy was done using a polarizing light microscope. Photographs were also taken of the cross-section of the pancakes and the top surface of the pancake.

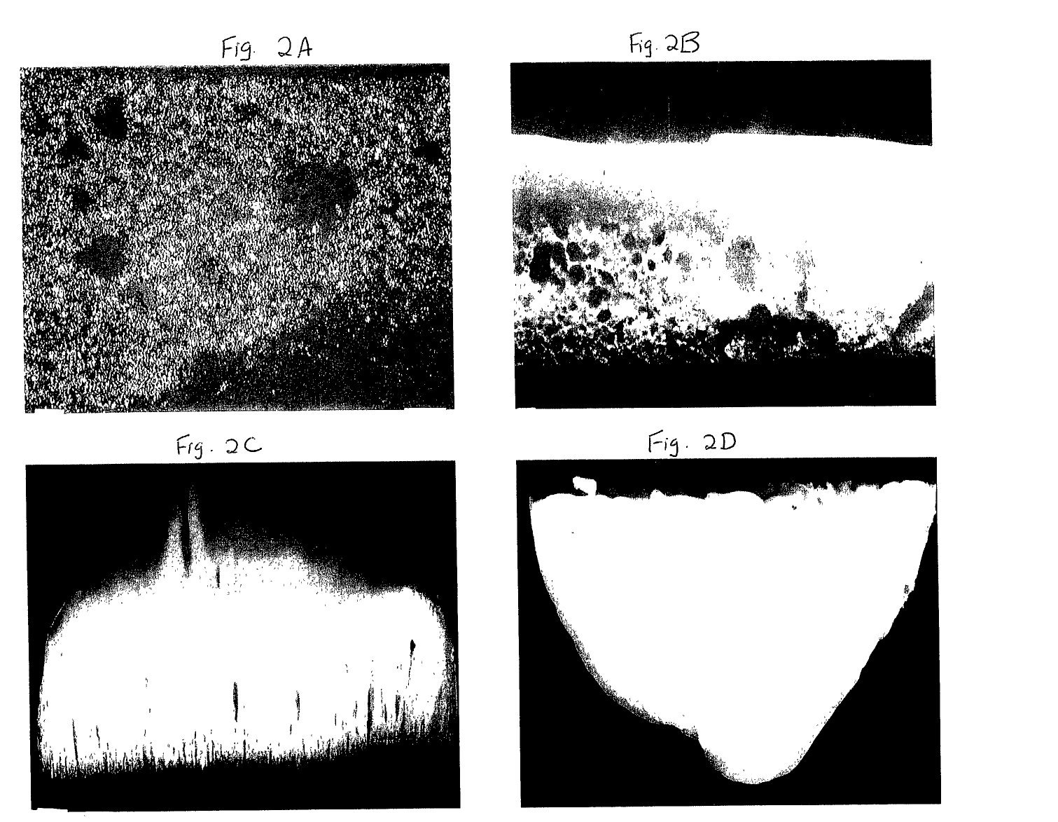

FIG. 2A-2D contains images of a pancake in which the center of the top surface was at 120° F. when the pancake was removed from the griddle and frozen. FIG. 2A is a microscopy image that shows a substantially crystalline structure. The crystalline structure in the microscopy image is indicative of the presence of ungelatinized batter. FIG. 2B-2D show that pancake components at this temperature are only partially set and have runny batter that would spill if flipped over.

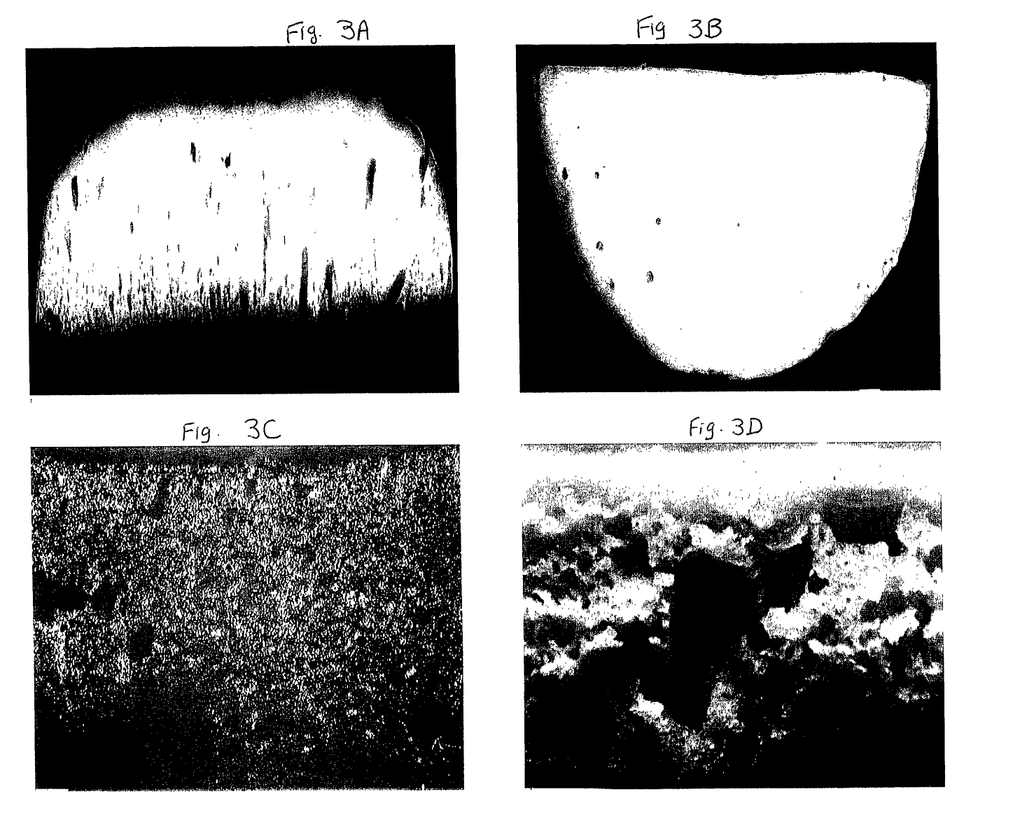

FIG. 3A-3D contains images of a pancake in which the center of the top surface was at 140° F. when removed from the griddle and frozen. FIG. 3C shows that about a quarter of the pancake component at the bottom now has a translucent structure with the remaining still being a crystalline structure. The increase in the amount of translucent structure in FIG. 3C compared to FIG. 2A is indicative of an increased amount of gelatinized batter. Pancake components with edges having electon microscopy images similar to 3C are appropriately sticky for combining with another pancake component. FIG. 3A and FIG. 3D show a set structure without runny batter that is appropriate for depositing filling and flipping over.

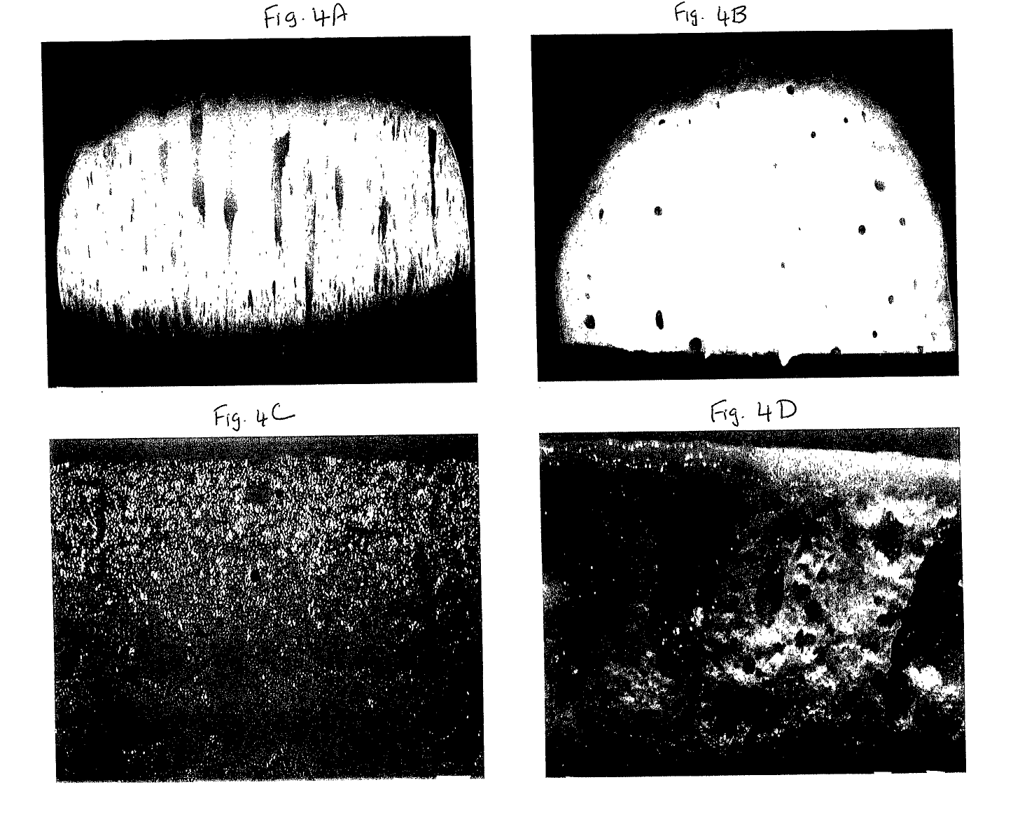

FIG. 4A-4D contains images of a pancake in which the center of the top surface was at 160° F. when removed from the griddle and frozen. FIG. 4C shows a significant amount of translucent structure indicative of more extensive gelatinization of batter compared to FIG. 3C. The surface of the pancake was mostly set, however, pancake components with edges in this stage would lose the stickiness required. In addition, inappropriate amount of batter was left for adherence. There appears to be very little uncooked batter on the surface.

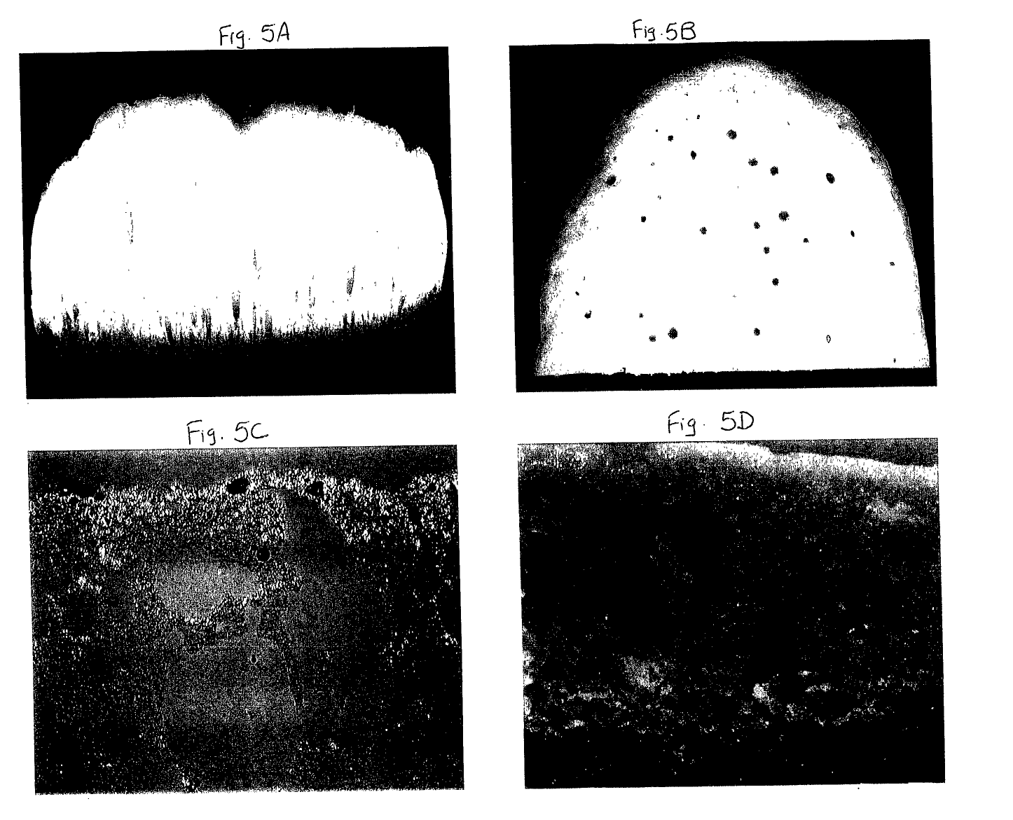

FIG. 5A-5D contains images of a pancake in which the center of the top surface was at 180° F. when removed from the griddle and frozen. FIG. 5C shows a predominantly translucent structure with very little crystalline structure remaining. FIG. 5A, 5B, and 5D indicate that almost all of the batter has set. Pancake components with edges similar to FIG. 5A-5D would be dry and non-sticky.

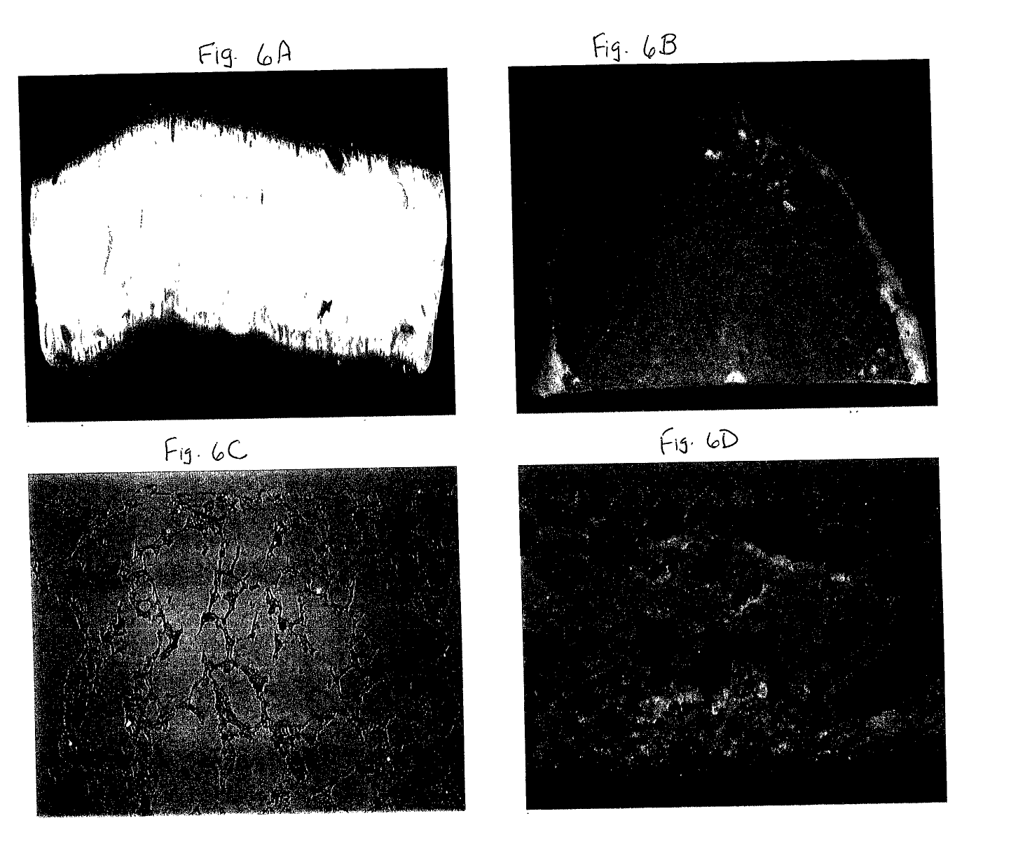

FIG. 6A-6D contains images of a completely cooked pancake. FIG. 6C indicates that all the batter has gelatinized due to the presence of a substantially translucent image. There is no visual indication of any ungelatinized batter in FIG. 6A, 6B or 6D.

Although the present invention has been described with reference to preferred embodiments, workers skilled in the art will recognize that changes may be made in form and detail without departing from the spirit and scope of the invention.

What is claimed is:

1. A filled food product comprising a food structure and a filling, wherein the filling is encased within the food structure, the food structure comprising cooked, hydrated flour and a moisture content between about 20 percent by weight and about 60 percent by weight.

2. The filled food product of claim 1, wherein the moisture content is between about 25 percent by weight and about 55 percent by weight.

3. The filled food product of claim 1, wherein the food structure comprises at least about 20 percent by weight of flour.

4. The filled food product of claim 1, wherein the food product has a continuous spongy structure.

5. The filled food product of claim 1, wherein the food product is a filled pancake.

6. The filled food product of claim 5, wherein the diameter of the pancake is between about 2 to about 5 inches.

7. The filled food product of claim 5, wherein the diameter of the pancake is between about 3.0 inches to about 4.0 inches.

8. The filled food product of claim 5, wherein the thickness of the pancake is between about 8 millimeters to about 20 millimeters.

9. The filled food product of claim 5, wherein the thickness of the pancake is between about 10 millimeters to about 15 millimeters.

10. The filled food product of claim 1, wherein the filling comprises fruit.

11. The filled food product of claim 1, wherein the filling is selected from a group consisting of apple filling, strawberry filling, raspberry filling, blueberry filling, pineapple filling, whipped maple syrup and mixtures thereof.

12. A method of making a filled food product comprising:
combining two food components with at least one food component having an ungelatinized top layer wherein the ungelatinized top layer interacts with the other food component after combining, one of the food components comprising a filling; and
bonding the two combined food components to encase the filling within the bonded structure.

13. The method of claim 12, wherein the two food components have ungelatinized top layers and the two ungelatinized top layers interact after combining.

14. The method of claim 12, wherein the food components are partially cooked pancake components and the food product is a filled pancake.

15. The method of claim 12, wherein the bonding is done by further heating.

16. The method of claim 12, wherein the food component without the filling is placed on top of the food component with the filling.

17. The method of claim 12, wherein the food component with the filling is placed on top of the food component without the filling.

18. The method of claim 12, wherein both of the food components have a filling.

19. The method of claim 12, wherein the filling is deposited when the center of the food component is structurally set to hold the filling.

20. The method of claim 12, wherein the filling is deposited when edges of the top surface of the food component are between about 130° F. and about 145° F.

21. The method of claim 12, wherein about a quarter of the batter is gelatinized when the two food components are combined.

22. The method of claim 14, wherein the diameters of the pancake components are between about 2 inches and about 5 inches.

23. The method of claim 14, wherein the diameters of the pancake components are between about 3.0 inches and about 4.0 inches.

24. The method of claim 14, wherein the thickness of the filled pancake is between about 8 millimeters and about 20 millimeters.

25. The method of claim 14, wherein the thickness of the filled pancake is between about 10 millimeters and about 15 millimeters.

26. The method of claim 14, wherein the viscosity of the batter used to make the pancake components is between about 20,000 centipoise and about 1000 centipoise at 20 rpm.

27. The method of claim 14, wherein the viscosity of the batter used to make the pancake components is between about 500 centipoise and about 16,000 centipoise at 20 rpm.

28. A method of making a filled food product comprising:
depositing a filling within a partially cooked food composition; and
heating the food composition further to produce the filled food product.

29. The method of claim 28, wherein the food composition includes a sufficient spongy structure to retain the filling.

30. The method of claim 28, wherein the food product has a moisture content of at least 20 percent by weight.

31. The method of claim 28, wherein the partially cooked food composition with the filling is combined with another partially cooked food composition prior to further heating.

32. The method of claim 28, wherein the filling is injected.
